(19) United States
(12) Patent Application Publication
(10) Pub. No.: US 2015/0302343 A1
(43) Pub. Date: Oct. 22, 2015

(54) MONETIZATION OF PRIORITY QUEUE

(71) Applicant: Zafir Anjum, Chico, CA (US)

(72) Inventor: Zafir Anjum, Chico, CA (US)

(21) Appl. No.: 14/681,004

(22) Filed: Apr. 7, 2015

Related U.S. Application Data
(60) Provisional application No. 61/981,676, filed on Apr. 18, 2014.

(51) Int. Cl. G06Q 10/06; G06Q 30/08

(52) U.S. Cl. CPC G06Q 10/063114; G06Q 30/08

(57) ABSTRACT

A method and system for monetization of a priority queue are disclosed. Priority of an item in a queue remains in flux till the item exits from the queue. Priority of an item is based on bids associated with the item and may be additionally based on the number of bidders associated with the item, the resources required by the item, and the time the item spends in the queue. Bids on the items in a queue may change while they are in the queue. More than one person may bid to increase the priority of the same item. A bidder may even retract his or her bid while the item is still in the queue.

### CROSS-REFERENCE TO RELATED APPLICATION

This application claims priority and the benefit, under 35 U.S.C. § 119(e), of U.S. Provisional Patent Application 61/981,676, filed Apr. 18, 2014.

### FIELD OF INVENTION

The present invention is related to queuing, and in particular, to apparatus and processes for queuing access to resources.

### BACKGROUND

Work tasks can be placed in one or more queues for task performers to pull out of the queues and process. Depending on the need, different numbers of task performers can be assigned to process tasks in a given queue. One simple scheme to determine which tasks are removed from a queue by a task performer is “first in/first out” where the first task into the queue is processed before the second task is processed. However, this simple scheme is not flexible and does not take into account the desire of task beneficiaries for a faster turnaround.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

A method and system for monetization of a priority queue are disclosed. Priority of an item in a queue remains in flux till the item exits from the queue. Priority of an item is based on bids associated with the item and may be additionally based on the number of bidders associated with the item, the resources required by the item, and the time the item spends in the queue. More than one person may bid to increase the priority of the same item. Bids on the items in a queue may change while they are in the queue. A bidder may even retract his or her bid while the item is still in the queue. When a resource is available to process an item, the item with the highest priority in the queue that is suitable for processing by the available resource is retrieved from the queue and matched with the available resource.

In various embodiments, priority of an item in a queue increases with its age in the queue. This ensures that an item as it waits to be processed, even if it has no sponsor, will eventually reach a priority that it is retrieved from the queue for processing.

Additional aspects and/or advantages will be set forth in part in the description and, in part, will be apparent from the description that follows, or may be learned by practice of the invention.

### BRIEF DESCRIPTION OF DRAWINGS

FIG. 1 illustrates an example environment in which the systems and methods discussed herein can be implemented.

FIG. 2 depicts a flowchart describing a process for managing a queue.

FIG. 3 is a high-level block diagram of apparatus that may be used to effect at least some of the various operations that may be performed in accordance with the present invention.

### DETAILED DESCRIPTION

Reference will now be made in detail to embodiments of the claimed subject matter, a method and system for advertiser monetization, examples of which are illustrated in the accompanying drawings. While the claimed subject matter will be described in conjunction with the embodiments, it will be understood that they are not intended to be limited to these embodiments. On the contrary, the claimed subject matter is intended to cover alternatives, modifications and equivalents, which may be included within the spirit and scope as defined by the appended claims.

Furthermore, in the following detailed descriptions of embodiments of the claimed subject matter, numerous specific details are set forth in order to provide a thorough understanding of the claimed subject matter. However, it will be recognized by one of ordinary skill in the art that the claimed subject matter may be practiced without these specific details. In other instances, well known methods, procedures, and systems have not been described in detail as not to unnecessarily obscure aspects of the claimed subject matter.

Some portions of the detailed descriptions which follow are presented in terms of procedures, steps, processes, and other symbolic representations of operations on data on computer memory by one or more processing units. They may take the form of electrical or magnetic signals capable of being stored, transferred, combined, compared, and otherwise manipulated in a computer system.

### Introduction

Accordingly, embodiments of the claimed subject matter provide a method and system for monetization of prioritized queues. Bidders bid for higher priority for an item in a queue. The criteria for raising the priority of an item include the bid value on the item and the duration the item has been in the queue. The priority of an item may additionally be based on other factors. Exit of an item from the queue is based on the priority and the resource(s) required by the item.

One area of application is a question-answer system. Users may ask questions and whoever is interested in a question being answered may boost its priority by bidding on it. This will cause the question to be offered sooner to an expert capable of answering the question.

However, if the priority were to be solely based on the total bid, it is conceivable that questions with no or low bids would never reach a priority high enough to be offered to an expert for an answer. Therefore, additionally increasing the priority based on the duration the question is waiting in the queue will eventually raise the priority of any item to the highest in the queue.

### Environment

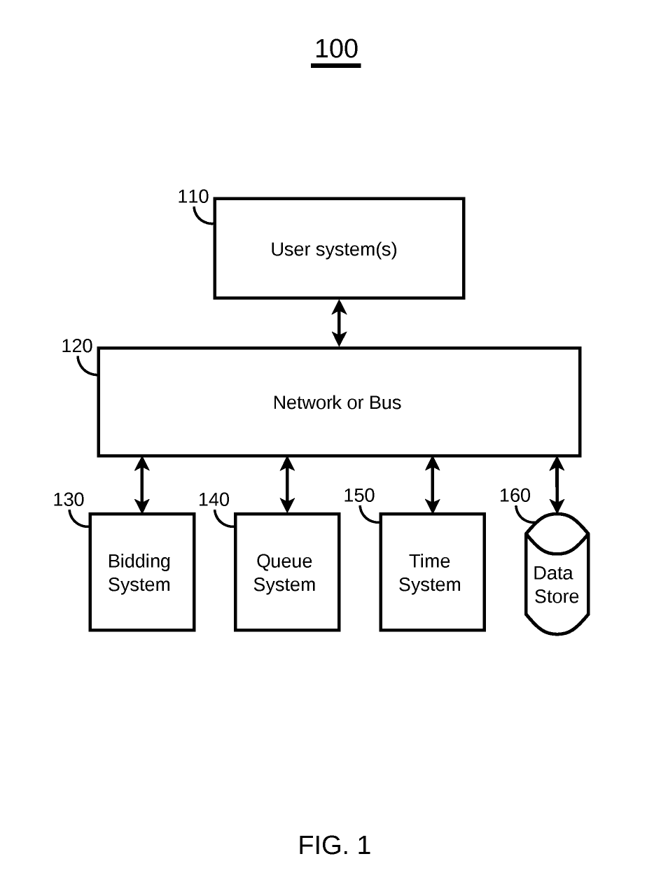

FIG. 1 illustrates an example environment 100 in which the systems and methods discussed herein can be implemented. Environment 100 includes user system(s) 110, network or bus 120, bidding system 130, queue system 140, time system 150, and data store 160. Bidding system 130, queue system 140, time system 150, and data store 160 may be connected to each other via network or system bus 120 and to user system(s) 110 over a network. A data store is computer-readable media that is not a transitory, propagating signal. A user using user system(s) 110 requests that an item be inserted into the queue. The type of items to be inserted into a queue include tasks to be performed by a computer or by a person or an object to be transformed by a computer or a person. The items in a particular queue may be restricted to a qualifying type of item.

Queue system 140 receives the item from the user via network or bus 120 and inserts it into the queue. In various embodiments, the user specifies attributes of resources that the item may be matched with. In various embodiments, the insertion point is the end of the queue and the item is assigned the lowest priority. In various embodiments, an initial priority may be assigned to an item before insertion into the queue. The initial priority may be based on known attributes of the user who submitted the request. The initial priority may additionally or alternatively be based on known attributes of the item to be inserted into the queue. Queue system 140 maintains the queue as a data structure on data store 160.

While an item is in a queue, bidding system 130 may receive new bids or updates to an earlier bid from one or more user. A user may update his or her own bids or another users bids with proper authorization. In many embodiments, a bid is associated with a monetary instrument. In various embodiments, a bid may be in the form or points or credits. The points or credits may have been awarded to users in response to certain user actions. Each bid is associated with an item in a queue. Bidding system 130 saves the bids to data store 160 and signals queue system 140 to update the priority of the item associated with the received bid. In some embodiments, a bid specifies a resource type that the associated item should be matched with.

Time system 150 influences the priority of items in a queue based on the duration that each item has been in the queue. In various embodiments, the priority increases linearly over time. In various other embodiments, the change in priority is a non-linear function of time. In various embodiments, time system 150 may affect the change in priority by creating a virtual bid on an item. Once time system 150 has processed all items that are to be affected, it signals queue system 140 to update the queues with the affected items. Time system 150 may initiate the update in priority based on a timer event or some other internal or external trigger.

Queue system 140 may remove an item from the queue on receiving a request from the user who caused insertion of the item into the queue in the first place. However, in various embodiments, an item is removed from a queue is when queue system 140 retrieves the item from the queue because the resource(s) needed by the item are available. The criteria for selecting the item to retrieve from a queue are based on the priority of the item and the availability of the resource(s) required to process the item. Of the items that are capable of being processed by available resources, the item with the highest priority is retrieved from the queue.

Example: Suppose a user wants a question answered and submits the question. The question is added to a queue of questions. While the question is waiting in the queue to be answered, one or more users may bid to increase the priority of the question. When an expert capable of answering questions is available to take on a new question, the question with the highest bid in the experts area of expertise is offered to the expert and removed from the queue. If a question remains unanswered for too long, the time system may increase its priority.

### Queue Operation

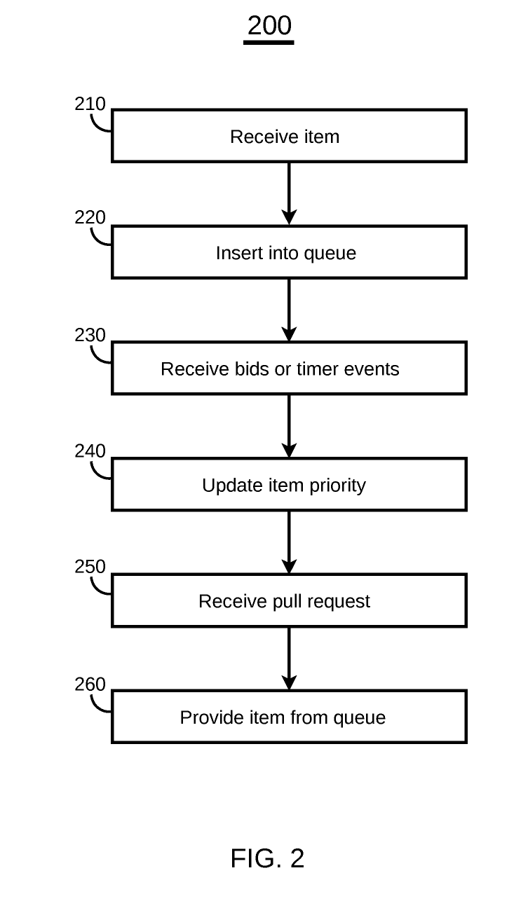

FIG. 2 depicts a flowchart describing a process 200 for managing a queue. Steps 210-260 describe exemplary steps comprising the process 200 in accordance with the various embodiments herein described. Process 200 may be typically available to users who already have an account associated with them. Further, the users' accounts may contain billing information. In various embodiments, if billing information is lacking from the account, the user may be prompted for it after process 200.

In step 210, an item is received from a user. In some embodiments the user must be a registered user. In some embodiments, the user may be an unregistered user. In some embodiments, an initial bid is received with the item. Next, in step 220, an initial priority is assigned to the item and the item is inserted into a queue. The queue itself may be persisted in a data store in a suitable data structure. The initial priority an item is based on any initial bid associated with the item. In some embodiments, the initial priority may additionally be based on one or more of: attributes of the user submitting the item, attributes of the item, resources that may be required to process the item and the anticipated time required to process the item.

The next two steps, step 230 and 240 get executed only if bid events or timer events occur. Both steps get executed each time such an event occurs. Any bid event or timer event is received in step 230. The bid event may be an update on an existing bid lowering or increasing the bid amount. In some embodiments, a bid may have a deadline specified. The deadline of a bid may be updated as well. If a deadline passes without the item exiting the queue to be processed, the bid becomes void. In some embodiments, a timer event is generated when a deadline passes. In some embodiments, the items in the queue are checked for expired bids—bids where the deadlines have passed—at regular intervals.

Once a bid is received in step 230, the associated item is updated to reflect the new or updated bid. Next, in step 240, the priority of the item associated with the bid is updated to reflect the changes due to the bid received or the timer event received. In most embodiments, the higher the total bid, the higher the priority. In some embodiments, the priority of an item is raised with rising number of bidders associated with that item. These updates are saved to the queue data in the data store.

Next, in step 250, a pull request is received when a resource that may be able to process an item becomes available. A pull request is a request to retrieve an item able to be processed by the available resource. In the following step, step 260, the item in the queue with the highest priority that is suitable for the available resource is retrieved from the queue and matched to the resource. In various embodiments, the item is removed from the queue after it is retrieved from the queue. In various embodiments, the item may remain in the queue till it is matched with a certain type of resource or a certain number of resources, either of which is be based on attributes of the item or based on the data provided with the item or based on a predetermined rule. The representation of the queue in the data store is updated accordingly. Consider an example. Suppose, items in the queue are tasks to be performed by a person, then whenever a person is available to perform a task, a pull request is received in step 250, and in step 260, of all items matching the skills of the available person, the one with the highest priority is retrieved from the queue and provided to the person. Consider another example where an item in a queue is a survey question. In this example, based on the data provided with the survey question, the survey question is removed from the queue only after a specified number of people have taken the survey.

In some embodiments, where an item has to be matched with a plurality of resources, the priority of the item is increased as it is matched with increasing number of resources. This will facilitate a faster turn around once processing of an item has begun.

In various embodiments, the bidders are charged the bid amount associated with the item at the time the item is matched with a resource. In various embodiments, the bidders are charged based on the bid amount associated with the item at the time the item is matched with a resource and the bid amount associated with the item having the next highest bid. For example, suppose the bid on the matched item is 100 points and the bid on the item with the next highest bid is 80 points, then the bidders may be charged 80 points plus a fraction of the difference (e.i. some fraction of 20 points).

### Exemplary Apparatus

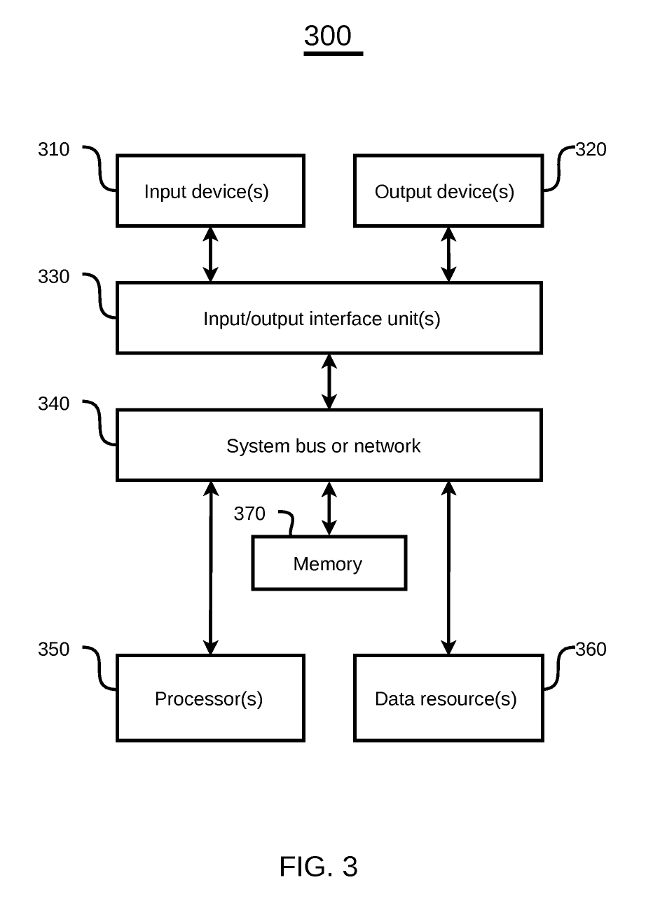

FIG. 3 is a high-level block diagram of apparatus 300 that may be used to effect at least some of the various operations that may be performed in accordance with the claimed subject matter. The apparatus 300 includes, inter alia, processor(s) 350, input/output interface unit(s) 330, data resource(s) 360, memory 370 and system bus or network 340 for facilitating the communication of information among the coupled elements. Input device(s) 310 and output device(s) 320 may be coupled with input/output interface(s) 330.

Processor(s) 350 may execute machine-executable instructions to effect one or more aspects of the claimed subject matter. At least a portion of the machine executable instructions may be stored (temporarily or more permanently) in memory 370 and/or on data resource(s) 360 and/or may be received from an external source via input/output interface unit(s) 330.

In one embodiment, apparatus 300 may be one or more conventional personal computers. In this case, processor(s) 350 may be one or more microprocessors. System bus or network 340 may include a system bus, internet, wide area network, local area network, wireless network etc. Data resource(s) 360 is capable of providing mass storage for the apparatus 300. In one implementation, data resource(s) 360 is a non-transitory computer-readable medium. In various different implementations, data resource(s) 360 can include, for example, a hard disk device, an optical disk device, a storage device that is shared over a network by multiple computing devices (e.g., a cloud storage device), or some other large capacity storage device. Memory 370 stores information within the apparatus 300. In one implementation, the memory 320 is a computer-readable medium. In one implementation, the memory 370 is a volatile memory unit. In another implementation, the memory 370 is a non-volatile memory unit.

A user may enter commands and information into the personal computer through input device(s) 310, such as a keyboard and pointing device (e.g., a mouse) for example. Other input devices such as a microphone, a joystick, a game pad, a satellite dish, a scanner, a touch surface, or the like, may also (or alternatively) be included. These and other input devices are often connected to processor(s) 350 through an appropriate interface 330 coupled to the system bus 340. However, in the context of some operation(s), no input devices, other than those needed to accept queries, and possibly those for system administration and maintenance, are needed.

Output device(s) 320 may include a monitor or other type of display device, which may also be connected to the system bus 340 via an appropriate interface 330. In addition to (or instead of) the monitor, the personal computer may include other (peripheral) output, such as speakers and printers for example.

In various embodiments, apparatus 300 can be a device such as mobile computing devices, mobile communication devices, set-top box television client devices, etc.

Although an example apparatus has been described in FIG. 10, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results.

1. A computer-implemented method for monetization of queues comprising:
receiving, from a user, an item for a queue;
inserting, by a processor, said item into said queue;
receiving one or more bids for raising priority of said item from at least one bidder;
assigning an initial priority to said item;
adjusting priority of said item based on said bids;
adjusting priority of said item based on its age in said queue; and
saving said bids in a data store.

2. The method of claim 1, wherein the priority of said item is increased with its age in said queue.

3. The method of claim 2, further comprising adjusting the priority of said item based on its attributes.

4. The method of claim 2, wherein at least on of said bids include offer of points or credits.

5. The method of claim 2, wherein at least one of said bids have an expiration time, whereafter said expired bids are void and any effect of said expired bids on the priority of said item is removed.

6. The method of claim 1, wherein said bids have a monetary component.

7. The method of claim 6, wherein the priority of said item is increased based on its age in said queue.

8. The method of claim 7, wherein the priority of said item is adjusted based on the number of said bidders.

9. The method of claim 8, wherein the priority of said item is adjusted based on resources required by said item.

10. The method of claim 6, further comprising saving said queue in a data store.

11. The method of claim 6, wherein said item is a task that requires human action to complete.

12. The method of claim 6, wherein priority of said item is adjusted when a bid is received or when a bid is modified or when a bid expires or when a bid is retracted or when a timer event occurs.

13. The method of claim 1, further comprising:
receiving, by a processor, criteria for retrieving an item from said queue; and
retrieving an item from said queue where said retrieved item has the highest priority of all items in said queue that satisfy said criteria.

14. The method of claim 13, further comprising removing said retrieved item from said queue.

15. The method of claim 13, further comprising:
receiving, by a processor, removal criteria; and
removing said retrieved item from said queue when said removal criteria are satisfied.

16. A computer system configured to perform a method according to claim 6.
